(19) United States
(12) Patent Application Publication
(10) Pub. No.: US 2006/0151534 A1
(43) Pub. Date: Jul. 13, 2006

(54) Freeze resistant hydration systems

(76) Inventor: Vincent C. Mares, Rohnert Park, CA (US)

Correspondence Address: KOLISCH HARTWELL, P.C., 200 PACIFIC BUILDING, 520 SW YAMHILL STREET, PORTLAND, OR, 97204, US

(21) Appl. No.: 11/330,801

(22) Filed: Jan. 11, 2006

Related U.S. Application Data
(60) Provisional application No. 60/644,237, filed on Jan. 12, 2005.

(51) Int. Cl. A45F 3/16; B67D 5/64

(52) U.S. Cl. 222/175; 224/148.2

(57) ABSTRACT

Personal hydration systems that include a pack assembly including at least one strap adapted to selectively couple the pack assembly to a pack carrier. The hydration system further includes a fluid reservoir adapted to be selectively received in the pack assembly. The fluid reservoir is further adapted to be selectively filled with a drink fluid. The hydration system further includes a downstream assembly adapted to be fluidly coupled to the reservoir at a proximal end thereof. The downstream assembly is further adapted to selectively dispense the drink fluid from a distal end thereof. At least one strap of the pack assembly includes a sleeve adapted to selectively receive at least a portion of the downstream assembly, such as at least a mouthpiece or other distal end thereof. The sleeve may include a heating region adapted to heat at least a mouthpiece or other portion of the downstream assembly.

### RELATED APPLICATION

This application claims priority to U.S. Provisional Patent Application Serial No. 60/644,237, which was filed on Jan. 12, 2005, and the complete disclosure of which is hereby incorporated by reference for all purposes.

### FIELD

The present disclosure is directed generally to personal hydration systems, and more particularly to hydration systems that include a heating, or heated, region.

### BACKGROUND

As used herein, the term “hydration system” refers to a fluid reservoir from which an elongate drink tube extends and terminates at a mouthpiece from which a user may draw drink fluid from the reservoir. The reservoir is often a flexible fluid reservoir that includes a resealable fill port through which potable drink fluid may be poured into the reservoir, and an exit port through which drink fluid may be drawn through the drink tube. The reservoir is typically housed in a body-mounted pack that enables the reservoir to be carried on a user's body. Conventional hydration systems include back-mounted backpack-style hydration systems, waist-mounted hydration systems, and hydration systems that include both waist and shoulder straps.

### SUMMARY

The present disclosure is directed to personal hydration systems that are adapted to maintain the temperature of the drink fluid in a desired range during use of the hydration systems in spite of ambient conditions that may be colder or hotter than the desired temperature range. For example, personal hydration systems within the scope of the present disclosure may resist or prevent freezing of the drink fluid in cold or freezing weather conditions. The hydration systems include a fluid reservoir that is adapted to receive and contain a volume of potable drink fluid. An elongate downstream assembly extends from the reservoir and enables a user to draw drink fluid from the reservoir, such as by sucking upon a mouthpiece that may form a portion of the downstream assembly. The downstream assembly may include a plurality of fluidly interconnected components, and typically will include at least an end region that fluidly interconnects the downstream assembly with the reservoir, at least one length of drink tubing through which the drink fluid may flow, and a mouthpiece or other outlet from which the drink fluid may be dispensed from the hydration system.

The reservoir, and typically a portion of the downstream assembly, is housed within a pack. The pack includes a strap assembly with at least one body-mounting strap, such as a pair of shoulder straps. Unlike conventional packs, the present hydration system includes a pack, reservoir, and/or downstream assembly adapted to be insulated against ambient conditions and, in some embodiments, to be selectively configured with a heating region to heat the drink fluid and/or for cold weather use to resist freezing of the drink fluid. The reservoir containing the volume of drink fluid may be configured to insulate the stored drink fluid from the ambient conditions. Additionally, portions of the downstream assembly may be insulated or include insulating features. The pack of the present hydration system may include one or more straps configured to selectively store, or enclose, at least a portion of the downstream assembly in a drink tube sleeve. When present, the straps that are configured to selectively store the downstream assembly may include a heating region disposed along at least a length, or region, of the strap. The heating region may be configured to supply heat to the mouthpiece of the downstream assembly and may also be configured to supply heat to the flexible tubing of the downstream assembly. The heating region may include one or more pockets configured to receive a heat source, such as may be adapted to heat portions of the downstream assembly that are stored within the corresponding strap.

### BRIEF DESCRIPTION OF THE DRAWINGS

FIG. 1 is a perspective view of a hydration system according to the present disclosure.

FIG. 2 is a rear elevation view of the hydration system of FIG. 1.

FIG. 3 is an isometric view of an illustrative hydration assembly.

FIG. 4 is a top plan view of another illustrative hydration assembly.

FIG. 5 is a top plan view of another illustrative hydration assembly.

FIG. 6 is a cross-sectional view of an illustrative bite-actuated mouthpiece in a closed configuration.

FIG. 7 is a cross-sectional view of an illustrative bite-actuated mouthpiece in a dispensing configuration.

FIG. 8 is a fragmentary plan view of an illustrative hydration system showing a downstream assembly exiting from a pack body and entering a drink tube sleeve.

FIG. 9 is a fragmentary perspective view of a strap of the hydration system of FIG. 1 showing the drink tube sleeve and a heating region.

### DETAILED DESCRIPTION

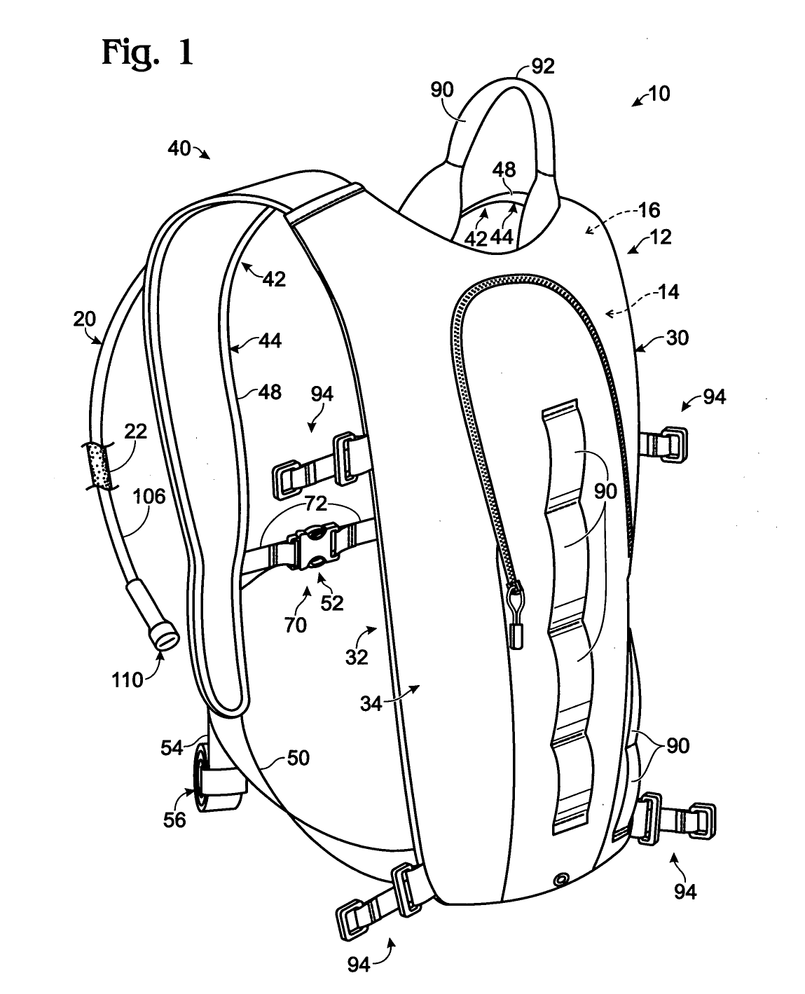

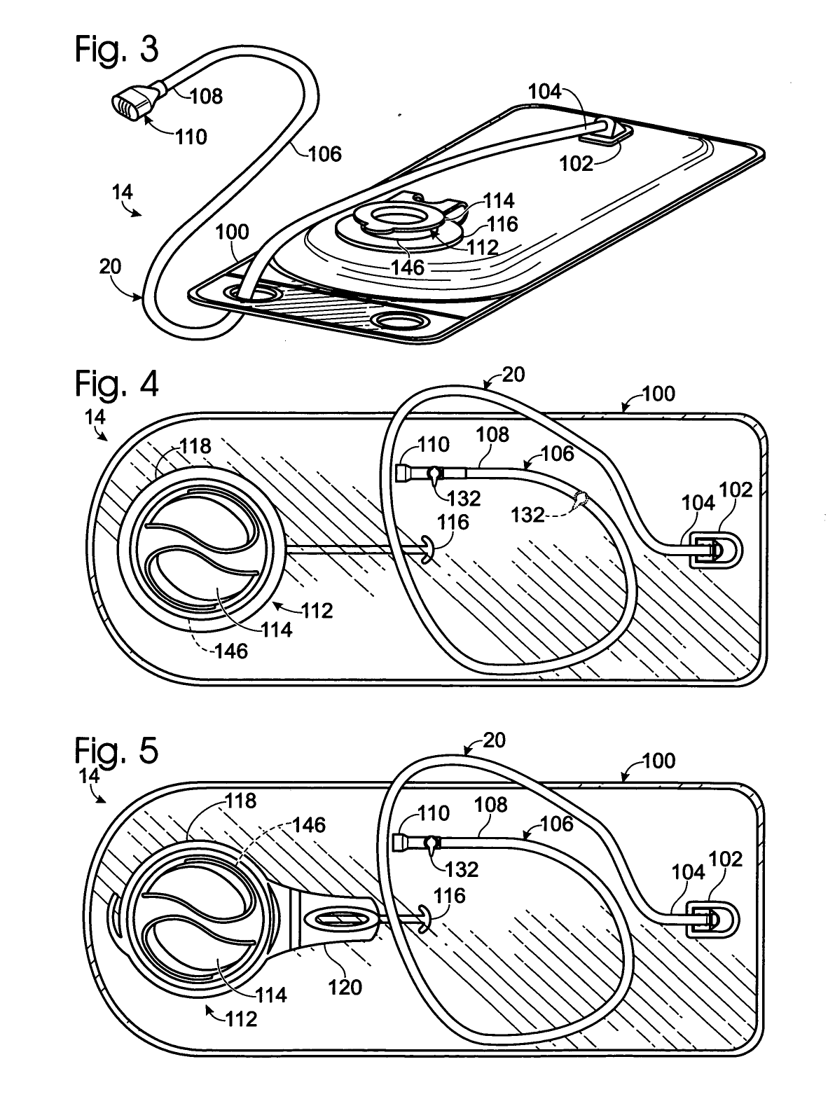

A personal hydration system according to the present disclosure is shown in FIG. 1 and generally indicated at 10. As shown, hydration system 10 includes a pack assembly 12 and a hydration assembly 14, which is at least partially received within a compartment 16 within the pack. More specifically, the hydration assembly includes a fluid reservoir that is housed within compartment 16 and an elongate downstream assembly 20 that extends in fluid communication with the reservoir from the compartment and terminates at a mouthpiece or other outlet from which water or other potable drink fluid may be drawn from the reservoir. Hydration assembly 14 is discussed in more detail herein, such as with respect to FIGS. 3-7.

Pack assembly 12 includes a pack body 30 that includes interior and exterior surfaces 32 and 34. Interior surface 32 refers generally to the surfaces, or portions, of the pack assembly that face and/or contact a user's body when hydration system 10 is worn on a user's body, such as when strapped on a user's torso, secured to a user's clothing, or otherwise worn as described herein. Exterior surface 34 refers generally to the surfaces, or portions, of the pack that face generally away from the user's body when the hydration system is worn or otherwise secured to a user's body. As used herein, the terms “interior surface” and “exterior surface” are intended to generally refer to the interior and exterior regions of the pack body, with it being within the scope of the present disclosure that these regions may be comprised of two or more surfaces, materials, etc., and that these regions are not required to be smooth, flat, continuous, etc.

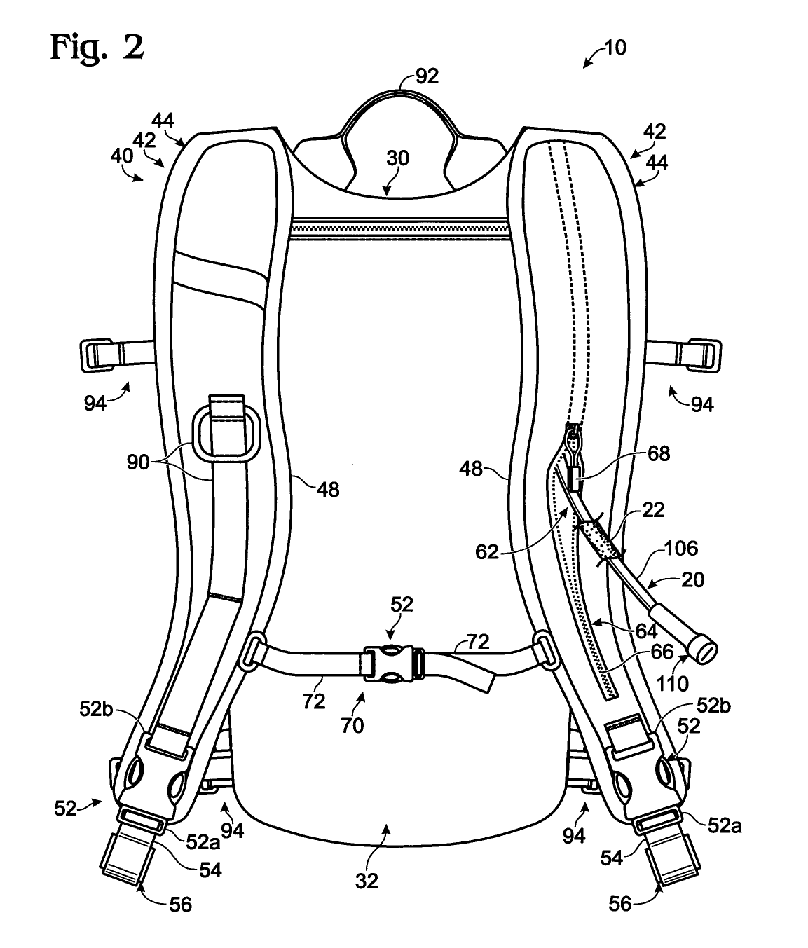

Interior surface 32 of pack body 30 is shown more clearly in FIG. 2. Interior surface 32 may be formed from a flexible material, and may optionally include or be at least partially formed from a padding material to cushion the engagement of the pack against the user's back or other body portion. Pack assembly 12, pack body 30 and/or interior surface 32 may, but are not required to, include a frame. When present, the frame may be utilized to support and/or define the shape of the pack body. Illustrative examples of frames for hydration systems are disclosed in U.S. Pat. No. 6,892,915, the complete disclosure of which is hereby incorporated by reference for all purposes. As indicated above, it is also within the scope of the present disclosure that the hydration system does not include a structural frame, such as may be formed from metal, molded plastic, or other suitable materials.

Also shown in FIGS. 1 and 2 is a harness assembly 40, which is designed to selectively mount the pack for carrying by a user, such as on a user's back. The harness assembly 40 may be adapted to be mounted to a variety of pack carriers, an example of which is a human user. In other examples, the harness assembly may be adapted to be coupled to a frame, to a coat or other apparel item, or to another apparatus that is adapted to be coupled to or carried by a user of the present hydration systems. In the illustrated example shown in FIG. 2, the harness assembly includes a pair of strap assemblies 42 that are adapted to extend around a pack carrier to support the pack thereupon. When used to directly secure the pack assembly 12 to a user's body, the strap assemblies may be referred to as body-securing strap assemblies in that they are configured to define a closed loop around a portion of a user's body, with the closed loop defined either entirely by the strap assembly, or by the strap assembly in combination with other elements of the pack assembly 12, such as the pack body 30. For example, in FIG. 2, harness assembly 40 includes a pair of strap assemblies 42 in the form of shoulder strap assemblies 44. Each shoulder strap assembly defines a closed loop through which a user's arm and shoulder may be inserted so that the shoulder strap assemblies secure and retain the pack on the user's back. The strap assemblies may include padded regions, such as to cushion the engagement of the hydration system with a user's body.

In the illustrative example shown in FIG. 1, each strap assembly 42 includes upper and lower strap members 48 and 50 that are either fixedly connected or releasably connected to the pack body 30. As used herein, the term “connected” includes either direct uninterrupted attachment or connection via an intermediate structure. For example, an end region of a strap member may be connected to the pack via a hip belt, D-ring, strap loop, clip, fastener, pack extender, or other intermediate structure. Similarly, as used herein, “fixedly connected” refers to mechanisms of securing an end region of a strap assembly to the pack body in a manner so that the end region may not be released or otherwise removed from its connection with the pack body without destroying at least a portion of the strap assembly, pack body, or intermediate structure that fixedly connects the two. In contrast, “releasably connected” refers to mechanisms for interconnecting an end region of a strap member with the pack body so that the end region is adapted to be repeatedly disconnected from and reconnected to the pack body.

In the illustrative embodiment shown in FIGS. 1 and 2, the strap members 48, 50 are adjustably and releasably connected together, such as to permit the size of the closed loop defined by the strap assembly and the pack body to be adjusted. For example, selectively resizing the closed loop may permit the hydration system to be sized for different sized users and/or to adjust the position of the hydration system relative to a particular user's body, such as by adjusting the relative vertical placement of the pack body relative to the user's body.

As perhaps best seen in FIGS. 1 and 2, the strap assemblies include at least one coupling member 52 that adjustably interconnects the strap members to define a closed loop with the pack body. In the illustrated embodiment, the coupling between the upper and lower strap members is formed by two interconnecting coupling members 52a, 52b. In other configurations, a single coupling member may be utilized, such as a ladder-lock coupler. As shown, lower strap member 50 is adjustably threaded through the first coupling member 52a and the upper strap member 48 is coupled to the second coupling member 52b. Other suitable methods of coupling the upper and lower strap members 48, 50 are within the scope of the present disclosure.

As illustrated in FIGS. 1 and 2, the lower strap member 50 includes a free end, or terminal length, 54 that extends from the first coupling member 52a and does not form part of the closed loop. This terminal length may hang loosely from the coupling member. In the illustrative example, the strap assemblies include strap management systems 56 that are adapted to secure the terminal length relative to the rest of the pack, such as to bundle and/or retain the terminal length proximate the coupling member 52 and/or the rest of one of the strap members. Illustrative examples of strap management systems are disclosed in U.S. patent application Ser. No. 10/185,428, the complete disclosure of which is hereby incorporated by reference for all purposes.

It is within the scope of the disclosure that the strap assemblies 42 may be formed from a single strap member that is adjustably or fixedly secured relative to the pack body to define a closed loop. It is further within the scope of the present disclosure that strap members 48 and 50 are releasably, but not adjustably, coupled together, or that they are adjustably, but not releasably, coupled together.

Also shown in FIGS. 1 and 2 is an optional sternum strap assembly 70, which selectively draws the strap assemblies 42 together. As illustrated, the sternum strap assembly 70 includes strap members 72, which are adjustably and releasably coupled together by a coupling member 52. The entire sternum strap assembly may be slidably adjustable within a range of positions along shoulder strap assemblies 44. For example, the sternum strap assembly may be configured to be selectively removed and replaced relative to shoulder strap assemblies 44. Additionally or alternatively, non-removable and/or non-adjustable sternum strap assemblies may be used as well, such as illustrated in FIGS. 1 and 2.

With reference to FIG. 1, a portion of a drink tube that forms a portion of downstream assembly 20 is shown extending from compartment 16 through an opening adjacent one of the pack's strap assemblies 42. Internal compartment 16 may include an opening adjacent both shoulder strap assemblies 44 to permit a user to selectively position the drink tube over either of the user's shoulders. Strap assemblies 42 and downstream assembly 20 will be discussed in greater detail below.

FIGS. 1 and 2 also illustrate that hydration system 10 may include a plurality of object-securing regions 90 that define fixed loops to which other objects may be tied, clipped or otherwise secured. Also shown is an optional carrying handle 92, which also may function as an object-securing region. Similarly, auxiliary strap assemblies 94 may be provided and configured to couple objects to the pack assembly, to allow the user to modify the shape or configuration of the pack assembly, and/or to further assist in coupling the pack assembly to the pack carrier. The object-securing regions 90 and auxiliary strap assemblies 94 illustrated in FIGS. 1 and 2 may be modified in any suitable manner to provide a hydration system pack assembly 12 of a suitable configuration.

As discussed, hydration system 10 includes a fluid reservoir that is housed within a compartment 16 within the hydration system's pack assembly 12. Compartment 16 is typically positioned between surfaces 32 and 34 of the pack body and may be accessible from the interior side and/or the exterior side of the pack body 30. The reservoir is selectively filled with a volume of potable drink fluid, such as water or a sports drink, and the pack body may be specifically sized to receive a fully charged fluid reservoir. In some applications, it may be desirable for the pack body to be as small as possible, and accordingly, the pack may not be designed to hold objects other than a fully charged fluid reservoir within the compartment. It is within the scope of the disclosure, however, that the pack may be designed to receive other objects into compartment 16 in addition to the reservoir and/or that the pack includes other compartments in addition to compartments 16, such as one or more storage pockets.

Illustrative examples of hydration assemblies 14 are shown in FIGS. 3-5 and include a reservoir 100 from which an elongate downstream assembly 20 extends and through which drink fluid is selectively dispensed from the reservoir. An exit port 102 fluidly interconnects the reservoir with the downstream assembly. In the illustrated example, the downstream assembly 20 is fluidly coupled to the exit port at a proximal end region 104 and includes at least one length of flexible tubing 106, which collectively or individually may be referred to as a drink tube. End region 104 may be fluidly coupled to the exit port via any suitable configuration, such as by being releasably mounted on exit port 102, fixedly or even integrally mounted on the exit port, or inserted through the exit port and into the internal chamber of the reservoir. A user draws drink fluid from a distal end region 108 of the downstream assembly, such as by sucking upon a mouthpiece 110. Accordingly, downstream assembly 20 should be sufficiently long that a user may comfortably draw drink fluid from the reservoir through the downstream assembly by sucking upon mouthpiece 110 when the hydration system is properly worn on a user's back or otherwise secured to a user's body, as described herein.

Reservoir 100 may be formed from any suitable rigid and/or flexible material. Preferably, the reservoir is at least substantially, if not completely, formed from a flexible material that is itself either waterproof or which includes a waterproof liner or other layer. An example of a suitable material is polyurethane, although others may be used. Reservoir 100 is preferably sized to hold at least 20 fluid ounces of drink fluid, and typically will include at least 50 oz. Illustrative examples of suitable reservoirs include reservoirs that are sized to hold 20-200 oz., or more, of drink fluid, such as 50 oz., 64 oz., 80 oz., 100 oz., 150 oz., etc.

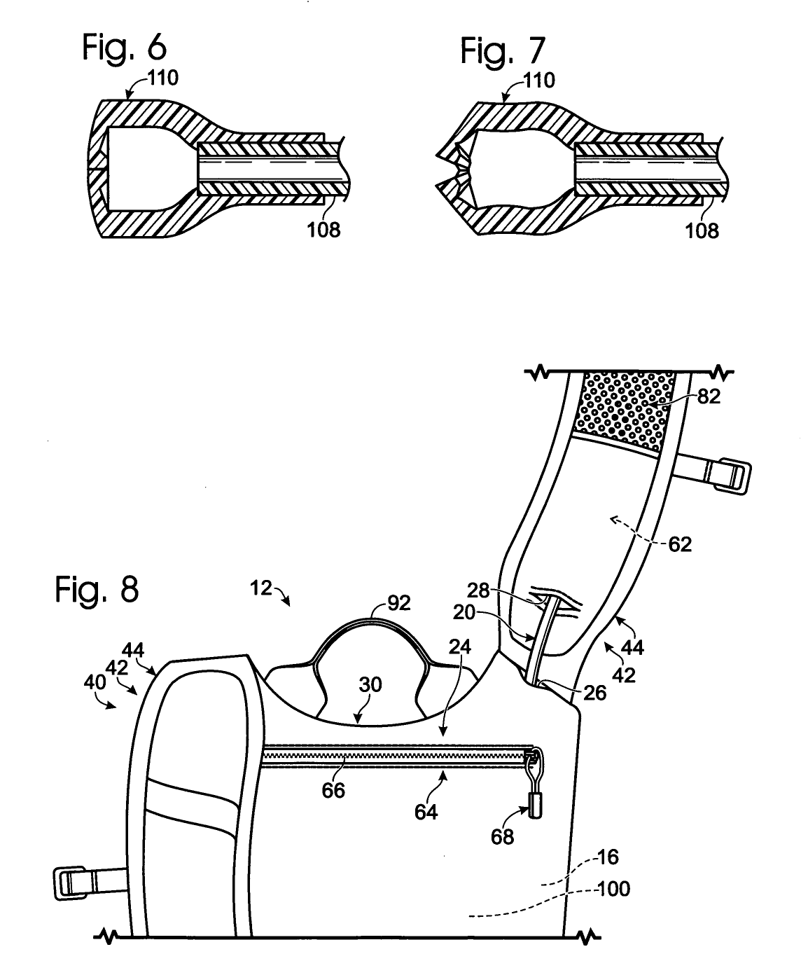

As shown in FIGS. 3-5, the downstream assembly terminates distal the reservoir at a mouthpiece 110. In the illustrated examples, mouthpiece 110 takes the form of a bite-actuated mouthpiece that is selectively configurable between a dispensing position, in which drink fluid may be drawn from the reservoir and through an outlet or opening in the mouthpiece, and a closed position, in which the opening is closed so that drink fluid cannot pass therethrough. In FIGS. 6 and 7, an illustrative bite-actuated mouthpiece is shown in its closed and dispensing positions, respectively. A bite-actuated mouthpiece is a resilient, self-sealing mouthpiece that is biased to the closed position, and is adapted to be configured to the dispensing position by a user placing the mouthpiece in the user's mouth and biting upon the appropriate sidewalls of the mouthpiece. Illustrative examples of bite-actuated mouthpieces are disclosed in U.S. Pat. Nos. 6,070,767, 6,032,831, and 6,364,168, the complete disclosures of which are hereby incorporated by reference for all purposes. It is within the scope of the disclosure that the hydration systems disclosed herein may be used with other bite-actuated mouthpieces, that the hydration systems may be used with mouthpieces that are not self-sealing mouthpieces and which therefore require manual manipulation between the dispensing and closed positions, and that the hydration systems may be used with mouthpieces that are integrated with the drink tube.

Reservoir 100 is preferably adapted to be selectively refilled, such as through a sealable fill port 146, and is in fluid communication with drink tube 106. The fill port may be selectively sealed by any suitable closure mechanism 112. In the illustrated examples, the reservoirs are shown including closure mechanisms 112 in the form of caps 114 that are removably coupled to the fill port to selectively seal the fill ports, although any suitable mechanism for selectively sealing the fill ports of the reservoirs may be used without departing from the scope of the present disclosure. In FIG. 3, the cap is adapted to seal the fill port through a simple friction fit, while in FIGS. 4 and 5, the caps are adapted to threadingly engage a corresponding set of threads on the fill ports. Any suitable closure mechanism and sealing mechanism(s) may be used.

In FIG. 3, the cap is coupled to the fill port by an optional tether 116 that extends from the cap and around the fill port. Tether 116 does not provide support to the fill port but does retain the cap proximate the fill port. In FIG. 4, fill port 146 is shown being sealed by a removable cap 114, with the fill port being supported by a collar 118 that extends around the fill port and provides support thereto. Also shown in FIG. 4 is another example of a suitable tether 1I16, with the illustrated tether extending within the reservoir when the fill port is sealed by the cap. In FIG. 5, the fill port includes a support collar with a projecting handle 120. Handle 120 may be used to position the reservoir for filling, and also may function as a counter-lever as the user twists or otherwise manipulates the cap to remove or secure the cap relative to the fill port. Preferably, the handle of the collar extends in a fixed orientation or limited range of rotational orientations relative to the fill port. In at least FIGS. 4 and 5, downstream assembly 20 is shown including an optional accessory in the form of a manually actuated on/off valve 132. On/off valve 132 enables a user to selectively prevent drink fluid from being able to be drawn through the reservoir regardless of the configuration of, or the forces being applied to, the mouthpiece. As shown, valve 132 interconnects end region 108 of the downstream assembly's drink tube and mouthpiece 110. It is within the scope of the disclosure that the valve may be otherwise positioned within the downstream assembly, such as between adjacent lengths of drink tubing and/or integrated with the mouthpiece or other components of the downstream assembly.

Additional examples of suitable structures for the hydration assemblies, and components thereof, are disclosed in U.S. Pat. Nos. 6,675,998, 6,070,767, and 6,032,831, as well as in U.S. patent applications Ser. Nos. 10/666,856 and 10/617,879, the complete disclosures of which are hereby incorporated by reference for all purposes.

It is within the scope of the disclosure that fill port 146 may be only accessible for filling the reservoir when the reservoir is removed from compartment 16. In such an embodiment, the pack body does not include a fill port opening through which the fill port, and more specifically cap 114 or any other utilized closure mechanism 112, may be accessed to selectively remove the cap (i.e., to open/unobstruct the fill port). Alternatively, the pack body 30 may include a fill port opening through which the fill port of the reservoir of the hydration assembly extends. In some embodiments, the fill port opening is formed in exterior surface 34 of the pack body and faces generally away from interior surface 32. Although this orientation is not required, it may be desirable because it orients the fill port and any cap or other closure mechanism away from the user's body in a position where the cap or other closure mechanism will not be pressed against the user's body when system 10 is properly worn.

Hydration systems 10 may be used in a variety of ambient conditions, including cold or freezing weather and hot weather. A user of the present hydration systems may prefer to receive the drink fluid at a temperature within a desired temperature range. Particularly, a user of hydration systems in cold weather generally prefers to prevent freezing of the drink fluid. To resist or prevent freezing of the drink fluid, or to resist other temperature changes due to ambient conditions, hydration system 10, pack assembly 12, and/or hydration assembly 14 may be provided with insulation. For example, reservoir 100 may be insulated from the ambient environment in a number of manners including constructing the reservoir of materials having insulative properties, wrapping or coating the exterior of the reservoir in insulating materials, or providing the pack body 30 or the compartment 16 in which the reservoir is disposed during use with insulation. Such configurations and others may be configured to adequately insulate the drink fluid in the reservoir.

The insulation provided to the fluid reservoir may be sufficient to resist significant temperature change of the drink fluid. For example, the insulation of the fluid reservoir may resist freezing of the drink fluid in the reservoir for an extended period of time under freezing conditions. In some configurations for example, the insulation may be configured to resist freezing for periods such as 1 hour, 3 hours, 6 hours, 12 hours, 18 hours, 24 hours, 36 hours or 48 hours in conditions as low as 15 degrees Fahrenheit. Other configurations may be configured to prevent freezing at lower temperatures and/or for longer periods of time.

As discussed above, and as shown in FIGS. 1 and 8, the downstream assembly 20 may exit compartment 16 adjacent to either of the strap assemblies 42. At least a portion of the downstream assembly 20, including the drink tube 106 may be insulated, such as by being wrapped or otherwise covered or enclosed with an insulating material. Additionally or alternatively, strap assemblies 42 may be configured to selectively store the portion of the downstream assembly 20 that is not stored in compartment 16 with reservoir 100.

With reference to FIGS. 2, 8, and 9, shoulder strap assembly 44 is shown including a drink tube sleeve 62 and a closure mechanism 64. Selectively enclosing downstream assembly 20 in strap assembly 42 may further insulate the downstream assembly from the cold or freezing environment external the strap assembly. The drink tube sleeve 62 may be adapted to receive and selectively store some or all of the remaining portions of the downstream assembly. For example, the drink tube sleeve 62 may be adapted to receive the majority of the portion of the downstream assembly that is not disposed in the pack body 30, including the mouthpiece or other distal end of the downstream assembly. In some embodiments, the strap assembly is adapted to receive and insulate and/or heat in its sleeve at least a mouthpiece of the downstream assembly, and in some embodiments, the mouthpiece and at least a substantial portion of the drink tube that extends from the pack body. In some embodiments, the combination of the insulation around the drink tube 106 and the selective storage of the drink tube in the drink tube sleeve 62 may be sufficient to prevent freezing of the drink fluid in the drink tube 106 in situations where the drink fluid would otherwise have frozen but for this structure. Similarly, the insulative materials may be effective to resist significant temperature changes due to ambient conditions, such as hot weather or temperatures that may not be cold enough to freeze the drink fluid but which are cold enough to lower the drink fluid temperature to an undesirable temperature.

As illustrated in FIG. 8, pack assembly 12 may be adapted to minimize or otherwise reduce the exposure of the hydration assembly to the ambient conditions. As illustrated, the reservoir 100 may be disposed in compartment 16 and accessible via opening 24, which may be selectively closed by closure mechanism 64. Closure mechanism 64 may include a zipper 66 and grip tab 68 or other suitable closure mechanisms. The closure mechanism may be oriented in any suitable direction to facilitate storage of the fluid reservoir 100. Opening 24 disposed in the interior surface 32 of the pack body 30 is illustrative of one possible configuration of the compartment 16. As discussed elsewhere herein, the compartment 16 may allow the reservoir to be inserted into the pack assembly from either the interior surface or the exterior surface.

With continued reference to FIG. 8, downstream assembly 20 is illustrated exiting the compartment 16 of the pack body 30 via exit port 26 and entering the drink tube sleeve 62 of the strap assembly 42 via inlet port 28. While the downstream assembly 20 is illustrated as exiting the compartment near the user's left shoulder and entering the left shoulder strap, hydration systems according to the present disclosure may be configured to enable the user to orient the downstream assembly in operative association with either of the shoulder strap assemblies, depending on the user's preference. Additionally or alternatively, hydration systems according to the present disclosure may be configured to allow the downstream assembly to exit the compartment on one side only and enter only one of the shoulder strap assemblies.

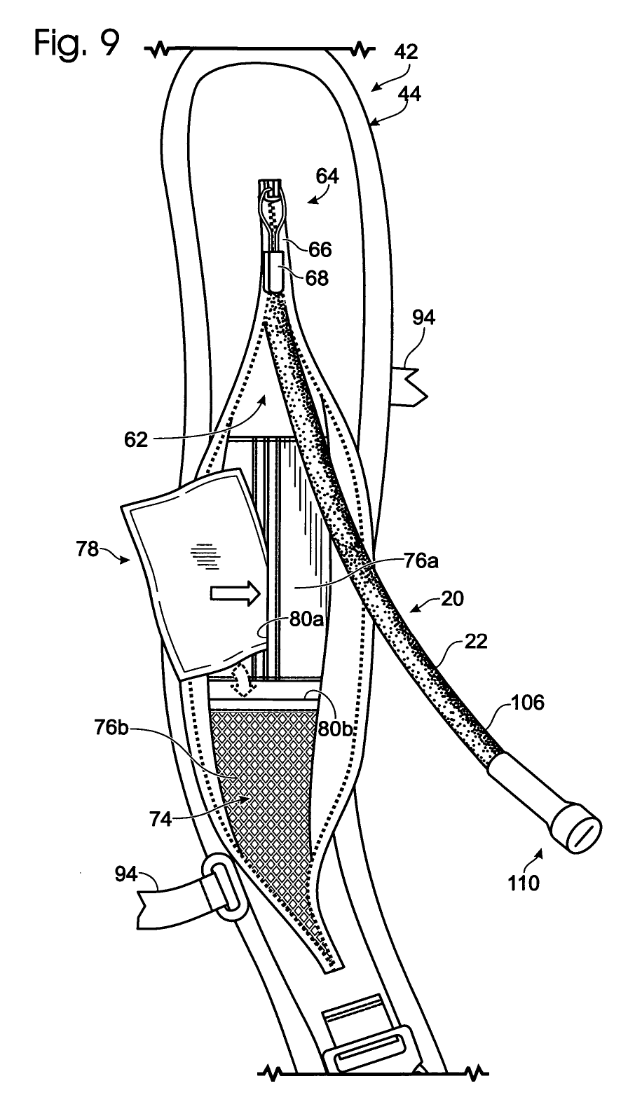

Strap assemblies 42 configured to provide a drink tube sleeve 62 may be configured to be easily opened and closed by the user for convenient storage and retrieval of the downstream assembly for access to the mouthpiece 110. As shown perhaps most clearly in FIGS. 2 and 9, drink tube sleeve 62 may be opened and closed via a closure mechanism 64 extending along at least a portion of strap assembly 42. In some embodiments, closure mechanism 64 may include zippers, such as zipper 66, hook and loop fasteners, snaps, buckles, or other convenient closure mechanisms. It is within the scope of the present disclosure that more than one type of fastener may be used to close the drink tube sleeve 62. As shown in FIGS. 2 and 9, zipper 66 may include grip tab 68 to facilitate opening and closing the zipper. When other closure mechanisms are used, comparable aids may be provided to facilitate the opening and closing of the drink tube passageway. With reference to FIG. 2, closure mechanism 64 is illustrated in solid lines as extending only part-way up the strap assembly 42. Additionally or alternatively, and as shown in dashed lines, the closure mechanism may extend along the entire length of the strap assembly.

As discussed above, the insulative properties of the pack body 30, the drink tube sleeve 62, and/or the insulation material 22 disposed around the downstream assembly may cooperatively or individually provide the hydration systems of the present disclosure with the ability to resist freezing in cold or freezing conditions, such as ambient temperatures/conditions external the pack that are at or below about 32 degrees Fahrenheit. For example, the insulation may be configured to prevent freezing for periods such as 2 hours, 4 hours, 6 hours, 12 hours, 18 hours, 24 hours, 36 hours, or 48 hours in conditions as low as 15 degrees Fahrenheit. Other configurations may be configured to prevent freezing at lower temperatures and/or for longer periods of time. Additionally or alternatively, some users prefer to maintain their drink fluid in a given temperature range. The insulative properties of the present hydration systems may enable a user to maintain the drink fluid in that desired range for a longer period of time. For example, a user in the summer may prefer colder fluids and a user in the winter may prefer warmer fluids, even if the ambient conditions are not likely to freeze the drink fluid.

As discussed above and with reference to FIG. 9, downstream assembly 20 may be selectively stored in drink tube sleeve 62. Downstream assembly 20 is illustrated in FIG. 9 as including an insulating sleeve 22 around drink tube 106 while mouthpiece 110 is left exposed. As illustrated most clearly in FIG. 9, strap assembly 42 may be provided with a heating region 74 adapted to heat mouthpiece 110 and/or other parts of the downstream assembly 20.

Heating region 74 may include one or more pockets 76 within the drink tube sleeve 62 that is configured to selectively receive a heat source 78. FIG. 9 illustrates two exemplary pockets 76 adapted to receive a heat source. The upper pocket 76a is illustrated with a vertical opening 80a disposed in the midsection of the pocket. The lower pocket 76b is illustrated with a horizontal opening 80b disposed in an end region of the pocket. The pockets 76 may be configured to provide openings 80 in any suitable configuration and/or location to enable a user to selectively insert a heat source 78 into the pocket 76.

FIG. 9 further illustrates that the pockets 76 may be made of any suitable material to retain the heat source 78 while still allowing the heat to be communicated to the downstream assembly. A mesh configuration, such as in pocket 76b, and/or a thermally conductive material, such as in pocket 76a, may allow the heat source to effectively prevent freezing of drink fluid in the mouthpiece, but this is not required.

While heating region 74 is illustrated in FIG. 9 as corresponding to the region proximate the mouthpiece, it is within the scope of the present disclosure that the heating region 74 may extend along a greater length of the strap assembly 42, including along the entire length of the strap assembly. In some embodiments, the strap assembly 42 and drink tube sleeve 62 may be configured with a plurality of heating regions 74 along the length of the shoulder strap assembly, such as the two or more pockets illustrated in FIG. 9. In hydration systems where downstream assembly 20 is able to exit compartment 16 adjacent either shoulder strap assembly, both strap assemblies may be provided with a drink tube sleeve 62 and heating regions 74.

Heat source 78 may include any suitable structure for proving heat to the corresponding components of the downstream assembly. Illustrative, non-exclusive examples of suitable heat sources that may be used in the heating region 74 include chemical reaction-based warmers, electrical resistance-based warmers, and thermal storage and dissipation-based warmers. Illustrative examples of chemical reaction-based warmers include packets containing one or more chemicals that undergo a reaction under controlled situations to produce heat over an extended period of time. In some chemical reaction-based warmers, two or more chemicals, which may be liquids, powders, gases, or other compositions, are maintained separated from each other until the heat source is to be used. When the seal or barrier between the chemicals is broken, the chemicals mix and produce heat as a byproduct of the reaction. In other chemical reaction-based warmers, a single chemical is disposed within a packet having an air-tight seal. The chemical reaction begins and heat is produced when the chemical is exposed to air. In these warmers, the air-tight seal is broken prior to use. As many of the chemical-reaction based heat sources may require air, or specifically oxygen, to carry out the reaction, strap assembly 42 may be adapted to allow a limited amount of ambient air to enter the drink tube sleeve to fuel the chemical reaction-based heat sources. For example, and as can be seen in FIG. 8, strap assembly 42 may be provided with a vented panel 82 to allow air into heating region 74. The vented panel 82 may include mesh material, porous material, perforated material, or other suitable materials for air to enter into the drink tube sleeve. The vented panel 82 may be sized and positioned to correspond with the heating regions 74, and particularly with the pockets 76 and the associated heat sources 78.

Electrical resistance warmers are another example of a suitable heat source 78 for use in heating region 74. For example, an electrical circuit including a battery and appropriate resistance elements may be configured to extend along at least a portion of strap assembly 42. When an electrical resistance warmer is used, the resistance elements may be built into the shoulder strap assembly with a conventional opening to the battery compartment, such as for when the battery or batteries need to be replaced. An on/off switch may be provided to allow the user to control when heat is applied. The on/off switch may be disposed adjacent the batteries or may be disposed in another location on the strap assembly 42 or pack assembly 12 in electrical communication with the batteries and/or resistance elements. Additionally, a heating control may be provided to control the amount of heat produced by the electrical resistance warmers. Additionally or alternatively, an electrical resistance heat source may be selectively received in a pocket 76 similar to the pocket described in connection with chemical reaction-based heat sources. A removable electrical resistance heat source may enable the user to selectively equip the pack assembly 12 with a heat source when desired and to remove the heat source when not needed.

Heat storage and dissipation-based warmers may include packets similar to those described above based on chemical reactions. These packets may include chemicals or materials that are configured to store heat quickly and to dissipate the stored heat slowly. For example, microwaveable packets include materials that are heated in the microwave over a short period of time to store heat. After removal from the microwave, the materials dissipate the heat slowly over time. Other heat storage and dissipation warmers may be configured to store heat received in other manners, such as by being placed in boiling water or adjacent other heat sources. When these packets are used in heating region 74 of the present disclosure, they release their stored heat over a period of time to provide heat to mouthpiece 110 or to other parts of the downstream assembly 20.

While heating region 74 is illustrated only in the strap assemblies 42 and associated with the downstream assembly 20, a heating region may be provided in the pack body 30 and in association with the fluid reservoir 100 to heat the drink fluid in the reservoir. A heating region in thermal communication with the fluid reservoir may be provided with pockets and heat sources similar to those described in connection with FIG. 9, the downstream assembly, and the strap assemblies 42. Extending the heating region into the pack body, or providing a separate heating region in the pack body may enable a user to better control the temperature of the drink fluid contained therein and to better resist freezing of the drink fluid in cold ambient conditions.

Other materials and configurations for heat source 78 are within the scope of the present disclosure. Heating region 74 may be adapted to provide heat to at least a portion of downstream assembly 20 to prevent freezing or to otherwise affect the temperature of the drink fluid dispensed from the downstream assembly. Heating region 74, drink tube sleeve 62, and any insulation 22 that may be provided to the drink tube 106, collectively or individually, may be adapted to prevent the drink fluid from freezing for an extended period of time in cold or freezing conditions, such as at or below 32 degrees Fahrenheit, in a range of 0-32 degrees Fahrenheit, in a range of 0-15 degrees Fahrenheit, in a range of 15-32 degrees Fahrenheit, etc. In some configurations, for example, the drink fluid may resist freezing for periods such as at least 1 hour, 1-6 hours, at least 3 hours, at least 6 hours, 12 hours, 18 hours, 24 hours, 36 hours or 48 hours in conditions as low as 15 degrees Fahrenheit. Other configurations, such as combinations of insulation and heat sources, may be configured to prevent freezing at lower temperatures.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Where the disclosure or subsequently filed claims recite “a” or “a first” element or the equivalent thereof, it should be within the scope of the present inventions that such disclosure or claims may be understood to include incorporation of one or more such elements, neither requiring nor excluding two or more such elements.

1. A personal hydration system, comprising:
a pack assembly including at least one strap adapted to selectively couple the pack assembly to a pack carrier;
a fluid reservoir adapted to be selectively received in the pack assembly and further adapted to be selectively filled with a drink fluid; and
a downstream assembly adapted to be fluidly coupled to the reservoir at a proximal end thereof and adapted to selectively dispense the drink fluid from a distal end thereof;
wherein at least one strap of the pack assembly includes a sleeve adapted to selectively receive at least a portion of the downstream assembly including the distal end thereof.

2. The personal hydration system of claim 1, wherein the sleeve includes at least one closure mechanism extending along at least a portion of the strap.

3. The personal hydration system of claim 1, wherein the sleeve is adapted to insulate the portion of the downstream assembly that is received against temperature change due to ambient conditions external the sleeve.

4. The personal hydration system of claim 1, wherein the sleeve includes a heating region adapted to selectively heat at least a portion of the downstream assembly received within the sleeve.

5. The personal hydration system of claim 4, wherein the heating region includes at least one heat source.

6. The personal hydration system of claim 5, wherein the heating region includes at least one pocket adapted to selectively receive the heat source.

7. The personal hydration system of claim 5, wherein the at least one heat source includes at least one heat source selected from the group consisting of chemical reaction-based sources, electrical resistance-based sources, and thermal storage and dissipation-based sources.

8. The personal hydration system of claim 5, wherein the at least one heat source includes at least one chemical reaction-based heat source, wherein the chemical reaction requires air as a reaction component, and wherein at least a portion of the sleeve includes one or more perforations adapted to allow air into the heating region.

9. The personal hydration system of claim 1, wherein the pack assembly is adapted to prevent freezing of the drink fluid in the reservoir and downstream assembly for at least three hours at ambient temperatures in the range of 15-32° F.

10. The personal hydration system of claim 1, wherein the pack assembly is adapted to prevent freezing of the drink fluid in the reservoir and downstream assembly for at least six hours at ambient temperatures in the range of 0-32° F.

11. The personal hydration system of claim 10, wherein the pack assembly is adapted to prevent freezing of the drink fluid in the reservoir and downstream assembly for at least 12 hours at ambient temperatures in the range of 0-32° F.

12. A personal hydration system, comprising:
a hydration assembly including a flexible fluid reservoir and a downstream assembly extending in fluid communication from the fluid reservoir, wherein the hydration assembly includes at least one length of flexible drink tubing and a mouthpiece from which a user may selectively draw drink fluid from the fluid reservoir;
a pack body including at least a compartment adapted to selectively receive the fluid reservoir; and
a harness assembly including at least one strap adapted to selectively couple the pack body to a pack carrier, wherein at least one strap of the harness assembly includes a sleeve adapted to selectively receive at least the mouthpiece of the downstream assembly, and wherein the sleeve includes at least one heating region adapted to selectively heat at least the mouthpiece of the downstream assembly.

13. The personal hydration system of claim 12, wherein the sleeve includes at least one closure mechanism extending along at least a portion of the strap and adapted to provide user access to the interior of the sleeve to selectively dispose at least a portion of the downstream assembly in the sleeve and to selectively remove at least a portion of the downstream assembly from the sleeve.

14. The personal hydration system of claim 12, wherein the sleeve is adapted to insulate at least the mouthpiece of the downstream assembly against temperature change due to ambient conditions external the sleeve.

15. The personal hydration system of claim 12, wherein the at least one heating region includes at least one heat source selected from the group consisting of chemical reaction-based sources, electrical resistance-based sources, and thermal storage and dissipation-based sources.

16. The personal hydration system of claim 15, wherein the at least one heating region includes at least one pocket adapted to selectively receive the at least one heat source.

17. The personal hydration system of claim 15, wherein the at least one heat source includes at least one chemical reaction-based heat source, wherein the chemical reaction requires air as a reaction component, and wherein at least a portion of the sleeve includes one or more perforations adapted to allow air into the heating region.

18. The personal hydration system of claim 12, wherein the pack body and the harness assembly are adapted to prevent freezing of the drink fluid in the reservoir and the downstream assembly for at least three hours at ambient temperatures in the range of 15-32° F.

19. The personal hydration system of claim 12, wherein the pack body and the harness assembly are adapted to prevent freezing of the drink fluid in the reservoir and the downstream assembly for at least three hours at ambient temperatures in the range of 0-32° F.

20. The personal hydration system of claim 19, wherein the pack body and the harness assembly are adapted to prevent freezing of the drink fluid in the reservoir and the downstream assembly for at least 12 hours at ambient temperatures in the range of 0-32° F.
